(19) United States
(12) Patent Application Publication
(10) Pub. No.: US 2010/0057479 A1
(43) Pub. Date: Mar. 4, 2010

(54) SYSTEM AND METHOD TO COMPUTE VEHICLE HEALTH INDEX FROM AGGREGATE DATA

(75) Inventors: Soumen De, Bangalore (IN); Pulak Bandyopadhyay, Bangalore (IN)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/198,447

(22) Filed: Aug. 26, 2008

(51) Int. Cl. G06Q 10/00; G06F 19/00

(52) U.S. Cl. 705/1; 702/34

(57) ABSTRACT

A system and method for determining the state of health of a vehicle based on a determination of factored miles. The method includes collecting data from a group of vehicle of a common model type as aggregate data and data from a particular vehicle as individual data. The aggregate data and the individual data are used to determine a percent degradation of sub-systems and components on the vehicle, and an overall percent degradation is determined by accumulating the percent degradation for the sub-systems and components. The accumulated percent degradation is then used to determine a factored miles value that is an indication of the state of health of the vehicle based on vehicle driving conditions and other considerations. The factored miles can then be used by various business models to determine the value of a vehicle.

### BACKGROUND OF THE INVENTION

1. Field of the Invention

This invention relates generally to a system and method for determining a vehicle health index and, more particularly, to a system and method for determining a vehicle health index using accumulated factored miles that are determined based on actual miles driven and the conditions under which the vehicle has been driven.

2. Discussion of the Related Art

Vehicle insurance companies, vehicle resale and other vehicle related institutions typically consider the number of miles that the vehicle has been driven and the number of months that the vehicle has been in service to determine the vehicle state of health and the value of the vehicle. Typically, insurance companies consider the number of miles a vehicle will be driven and possibly other factors when determining insurance rates for a particular vehicle, where discounts might be available for low-mileage drivers and vehicles equipped with certain safety and other features. For example, it is known that insurance discounts can sometimes be obtained for a vehicle employing various monitoring services, such as remote door unlock, road side assistance, stolen vehicle location assistance, automatic notification of airbag deployment, vehicle health management, etc. Also, a potential buyer of a used vehicle typically will only consider how old the vehicle is and how many miles it has been driven to determine it's value.

Because vehicle resale costs and insurance premium costs are typically decided only by vehicle mileage and age, and also to some extent on perception, there is no incentive for a vehicle user to follow recommended service cycles, recommended spare parts and following recommended driving habits. Also, there is no parametric way to characterize the perceived value of a used vehicle that has been used by a vehicle user fulfilling the above mentioned criteria.

The health of vehicle is typically determined by the vehicle sub-systems, such as the vehicle transmission, HVAC, engine, brakes, battery, etc. Thus, the number of miles a vehicle has been driven and the age of the vehicle typically does not tell the whole story as to the overall state of health of a vehicle. Particularly, driving conditions, such as repeated short-distance driving, extensive idling and/or slow-speed driving in stop and go traffic, driving on dusty roads, driving on hilly or mountainous terrain, towing a trailer, driving in heavy city traffic when the outside temperature is high, type of vehicle, such as police, taxi or delivery vehicles, frequent driving when the outside temperature is below freezing, etc., all are factors that can degrade the vehicles state of health over normal driving conditions. Therefore, a low mileage and newer vehicle that has been driven under harsh conditions may actually have a lower state of health than what its mileage and age would indicate. Likewise, favorable driving conditions can put the vehicle state of health higher than the actual miles driven. Consequently, these factors have an impact on insurance rates and resale value.

Thus, it would be desirable to provide a technique to assess a vehicle state of health based on additional factors, such as vehicle driving conditions.

### SUMMARY OF THE INVENTION

In accordance with the teachings of the present invention, a system and method are disclosed for determining the state of health of a vehicle based on a determination of factored miles. The method includes collecting data from a group of vehicle of a common model type as aggregate data and data from a particular vehicle as individual data. The aggregate data and the individual data are used to determine a percent degradation of sub-systems and components on the vehicle, and an overall percent degradation is determined by accumulating the percent degradation for the sub-systems and components. The accumulated percent degradation is then used to determine a factored miles value that is an indication of the state of health of the vehicle based on vehicle driving conditions and other considerations as compared to fleet average health. The factored miles can then be used by various business models to determine the value of a vehicle.

Additional features of the present invention will become apparent from the following description and appended claims, taken in conjunction with the accompanying drawings.

### BRIEF DESCRIPTION OF THE DRAWINGS

FIG. 1 is a flow chart diagram showing a process for collecting vehicle data and computing factored miles to determine the state of health of a vehicle;

FIG. 2 is a graph with percent degradation on the horizontal axis and factored miles on the vertical axis showing the relationship of factored miles as a percentage of degradation using a look-up table; and

FIG. 3 is a flow chart diagram showing a process for determining factored miles and using the factored miles for business decisions, according to an embodiment of the present invention.

### DETAILED DESCRIPTION OF THE EMBODIMENTS

The following discussion of the embodiments of the invention directed to a system and method for determining vehicle state of health based on a calculation of factored miles is merely exemplary in nature, and is in no way intended to limit the invention or its applications or uses.

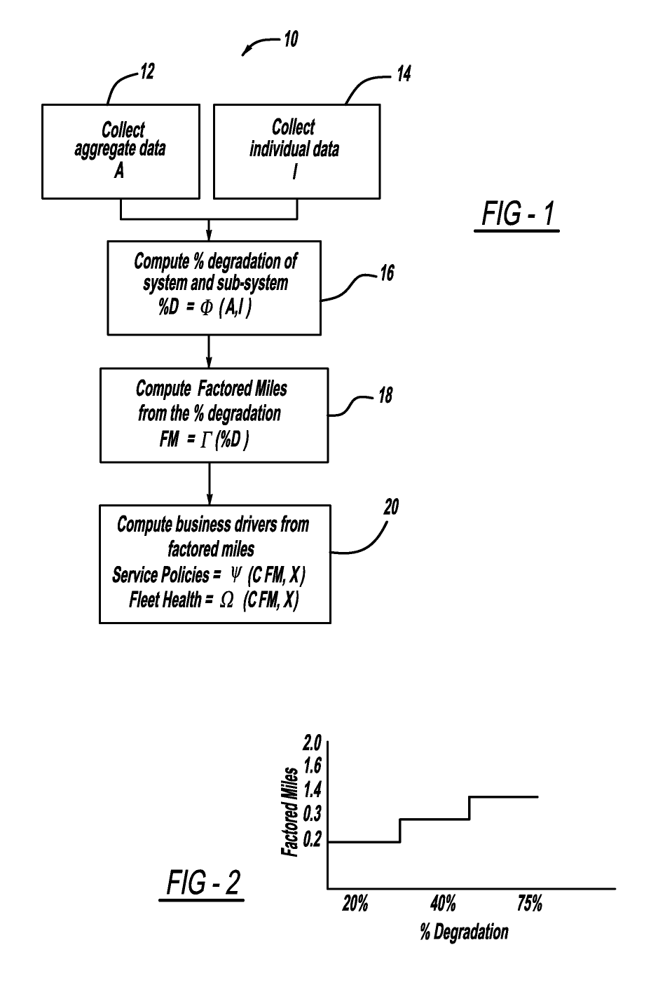

FIG. 1 is a flow chart diagram 10 showing a process for collecting vehicle data and using that data to determine factored miles (FM), according to an embodiment of the present invention. As mentioned above, a low mileage and newer vehicle that has been driven under harsh conditions may actually have a lower state of health than what its mileage and age would indicate. Likewise, favorable driving conditions can put the vehicle state of health higher than the actual miles driven. Thus, if the accumulated factored miles is less than the accumulated odometer miles, then the perceived health of the vehicle compared to the fleet average is presumed to be good.

Aggregate vehicle data is collected at box 12 and individual vehicle data is collected at box 14. Aggregate vehicle data refers to data collected by accessing various warranty, maintenance, service, etc. databases that are available for a specific vehicle model or type and looking at how various components and sub-systems on those vehicles have failed in the past, and what was the corresponding solution. Individual vehicle data refers to collected data from a specific vehicle as to how that vehicle has been driven, how often it was serviced, where it was driven, maintenance schedule, etc. Various techniques are known in the art for accessing the many and several databases that are available from warranty claims, insurance facilities, dealerships, service departments, etc. that can be used in the manner discussed herein. The present invention contemplates any type of data collection technique that is suitable for collecting the appropriate type of data for determining the state of health of a vehicle. For example, modern vehicles may be equipped with on-board modules that transmit data concerning the status of various vehicle components and sub-systems to a remote facility where that data can be stored and analyzed. The vehicle system, sub-system and component refer to any relevant component and systems on a vehicle that impact the vehicle health, such as the vehicle transmission, HVAC, engine, brakes, battery, generator, etc.

The process first computes a percent degradation (% D) of the different sub-systems and components, then aggregates the individual degradation into a system level degradation on a particular vehicle at box 16. Particularly, the process will look at each relevant component and/or sub-system on the vehicle and determine an a priori and post priori probability of component failure based on the collected data. The probability of the component failures can be used to calculate the percent degradation. The degradation of each individual component, such as those referred to above, is determined and used to provide an overall percent degradation of the vehicle itself. The percent degradation is hence a function of the aggregate data and the individual data and can be represented as % D=φ(A,I). The specific formula for calculating the percent degradation can be different for different vehicle models and vehicle types, and could be easily determined by those skilled in the art based on the desired application and results.

Once the process has calculated the overall percent degradation at the box 16, the process then computes the factored miles from the percent degradation at box 18. The factored miles is a function of the percent degradation as FM=Γ(% D), and can be provided by a look-up table. FIG. 2 is a graph with percent degradation on the horizontal axis and factored miles on the vertical axis showing how a look-up table can be used to determine factored miles based on percent degradation. The actual functions that compute the factored miles can be determined for various vehicle types and manufacturers, and would be readily apparent to those skilled in the art.

The process can be used to get different business indicators, which in turn can drive different business decisions, such as determining service policies, getting a summary of fleet health, etc. at box 20. For example, the service policies and fleet health can be a function of cumulative factored miles (CFM) and other factors (X). At this stage of the process, the factored miles are used in various business models for various applications. For example, business level service and warranty policy enhancements can be identified, a field assessment of a fleet of vehicles can be determined and proactive service decisions can be made for vehicle owners.

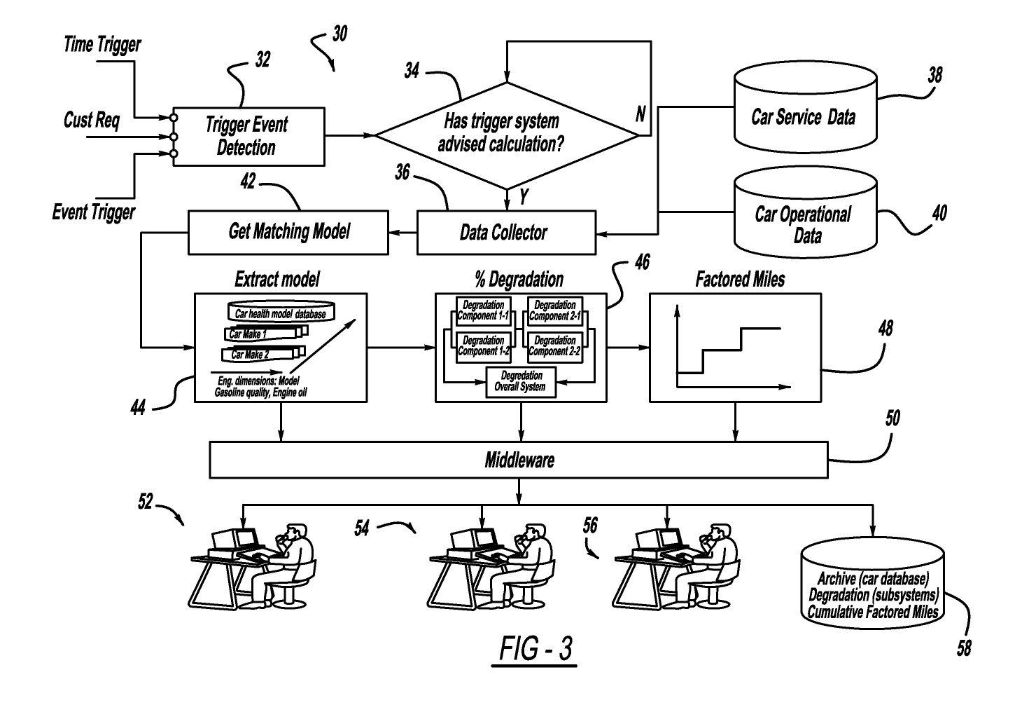

FIG. 3 is an illustration of an infrastructure 30 for determining vehicle state of health for a particular vehicle in the manner discussed above. The determination of vehicle state of health is triggered based on some occurrence, such as time, customer request or a certain event. If one of those predetermined triggers occurs, a trigger event detection box 32 detects the trigger. A decision diamond 34 determines whether the trigger event has occurred and, if so, provides data collection at box 36. As above, the data collection is provided as an aggregate data collection at box 38 and an individual data collection at box 40. The infrastructure 30 retrieves a matching model at box 42 for the data collected at the box 36, and extracts the model that matches the data at box 44. For a particular vehicle, the aggregate data for that vehicle model is determined. Once the information has been extracted for the particular model for a particular vehicle being assessed at the box 44, then the infrastructure 30 calculates the percent degradation at box 46 in the manner as discussed above. Once the percent degradation has been determined, then the factored miles are determined at box 38, such as by a look-up table.

The information from the extracted model at the box 44, the percent degradation at the box 46 and the factored miles at the box 48 are all sent to a middleware box 50 where the information is analyzed for vehicle state of health and is packaged for a particular business application. For example, the information determined from the state of health of the vehicle can be analyzed for service decisions at station 52, can be analyzed for warranty decisions at station 54, can be analyzed for determining the health assessment of a fleet of vehicle at station 56 and can be used to populate a car help database for that model using memory 58. Therefore, the various entities that have information concerning the factored miles of a particular vehicle or a particular vehicle fleet can use that information to determine the state of health of the vehicle, and appropriate apply it to any miles that they have for their business.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for determining the state of health of a vehicle or group of vehicles, said method comprising:
collecting data concerning the vehicle or group of vehicles;
using the collected data to determine a percent degradation of components and sub-systems on the vehicle or group of vehicles;
accumulating the percent degradation of the components and sub-systems on the vehicle or group of vehicles to provide an accumulated percent degradation;
computing a factored miles value based on the accumulative percent degradation for the vehicle or group of vehicles; and
using the factored miles value to determine the state of health of the vehicle or group of vehicles.

2. The method according to claim 1 wherein collecting data includes collecting aggregate data for vehicles of the same model or vehicle type and collecting individual data from a particular vehicle.

3. The method according to claim 2 wherein determining the percent degradation of the components and sub-systems includes determining the percent degradation as a function of the aggregate data and the individual vehicle data.

4. The method according to claim 2 wherein collecting individual data from a vehicle includes using wireless transmissions of data from the vehicle.

5. The method according to claim 1 wherein determining the percent degradation of vehicle components and sub-systems includes determining the percent degradation of a vehicle engine, vehicle brakes, vehicle HVAC, vehicle transmission and vehicle battery.

6. The method according to claim 1 wherein determining the percent degradation of the components and sub-systems includes determining the percent degradation as a function of engine health, brake health, actual vehicle miles, service history and driver driving habits.

7. The method according to claim 1 further comprising providing the factored miles value to business models that drive service decisions, that drive warranty decisions and that assess the health of a fleet of vehicles.

8. The method according to claim 1 wherein computing the factored miles value includes using a look-up table based on the accumulated percent degradation.

9. The method according to claim 1 wherein determining the state of health of the vehicle or group of vehicles includes determining the state of health based on a trigger event.

10. The method according to claim 9 wherein basing the determination of the state of health on a trigger event includes using a trigger event selected from the group consisting of a time trigger, a customer request trigger and an event trigger.

11. A method for determining a factored miles value of a vehicle that identifies vehicle value based on factors other than actual miles driven and months in service, said method comprising:
collecting data concerning the vehicle or a group of vehicles;
using the collected data to determine an accumulated percent degradation of the vehicle or group of vehicles;
computing the factored miles value based on the accumulated percent degradation; and
using the factored miles value to determine the vehicle value.

12. The method according to claim 11 wherein collecting data includes collecting aggregate data for vehicles of the same model or vehicle type and collecting individual data from a particular vehicle.

13. The method according to claim 11 wherein determining the accumulated percent degradation includes determining the percent degradation of separate components and sub-systems on the vehicle and combining the percent degradations of the components and sub-systems to provide the accumulated percent degradation.

14. The method according to claim 13 wherein determining the percent degradation of vehicle components and sub-systems includes determining the percent degradation of a vehicle engine, vehicle brakes, vehicle HVAC, vehicle transmission and vehicle battery.

15. The method according to claim 13 further comprising providing the factored miles value to business models that drive service decisions, that drive warranty decisions and that assess the health of a fleet of vehicles.

16. A method for determining the state of health of a vehicle or group of vehicles, said method comprising:
collecting aggregate data for vehicles of the same model or vehicle type as the vehicle or group of vehicles;
collecting individual data from a particular vehicle;
using the collected data to determine a percent degradation of components and sub-systems on the vehicle or group of vehicles where the components and sub-systems include a vehicle engine, vehicle brakes, vehicle HVAC, vehicle transmission and vehicle battery;
accumulating the percent degradation of the component and sub-systems on the vehicle or group of vehicles to provide an accumulated percent degradation;
computing a factored miles value based on the accumulated percent degradation for the vehicle or group of vehicles; and
using the factored miles value to determine the state of health of the vehicle or group of vehicles.

17. The method according to claim 16 further comprising providing the factored miles to business models that drive service decisions, that drive warranty decisions and that assess the health of a fleet of vehicles.

18. The method according to claim 16 wherein computing a factored miles value includes using a look-up table based on the accumulated percent degradation.

19. The method according to claim 16 wherein determining the state of health of the vehicle or group of vehicles includes determining the state of health based on a trigger event.

20. The method according to claim 19 wherein basing the determination of the state of health on a trigger event includes using a trigger event selected from the group consisting of a time trigger, a customer request trigger and an event trigger.
